(19) United States
(12) Patent Application Publication
(10) Pub. No.: US 2004/0231226 A1
(43) Pub. Date: Nov. 25, 2004

(54) Floating crab holder

(76) Inventors: Jim Yust, Baltimore, MD (US); Richard Yust, Glendora, NJ (US)

Correspondence Address: John E. Simms Jr., One Willow Avenue, Towson, MD, 21286-5227, US

(21) Appl. No.: 10/848,209

(22) Filed: May 18, 2004

Related U.S. Application Data
(60) Provisional application No. 60/472,625, filed on May 23, 2003.

(51) Int. Cl. A01K 97/00

(52) U.S. Cl. 43/55

(57) ABSTRACT

A floating crab holder having an underwater mesh enclosure and an above water access aperture for depositing crabs. The invention includes an easily operable door, which can be opened to insert a caught crab and closed to prevent the escape of a catch of crabs. The mesh enclosure is sufficiently rigid to retain its shape, while on a hard surface, so the invention can be set on a hard surface or floated while in use.

### REFERENCE TO RELATED APPLICATIONS

The applicant claims priority of this application based on the provisional application No. 60/472,625, for Floating Crab Holder filed 23 May 2003.

### BACKGROUND OF THE INVENTION

Recreational crabbing is a popular activity for people of all ages, who are enthusiastic about outdoor water activities and seafood. Crabbing is practiced from small boats, from docks or piers and from shore. Methods used to catch crabs, for recreation include trapping and dipping. In either case, crab bait must be reattached or replaced on lines or in traps. The lines and traps must be periodically checked and the crabs must be captured or removed. In any case, the process of catching a quantity of crabs to be cooked and consumed is generally an all day activity. Whether crabbers are in a boat, on a pier or on shore, the caught crabs must be kept until the end of the day and they must be kept alive, until they are cooked, in order to safely eat them. Crabs can walk and swim, so they must be confined, regardless of whether they are in water or out of water. Typically, crabbers use a basket, with a secured lid, in which to keep caught crabs. In order to keep the crabs alive, crabbers periodically take time to dip the basket into the water and allow water to flow through the basket, so that the crabs may use their gills to absorb oxygen from the water and thereby extend their lives. Care must be taken to avoid releasing the basket, which may sink if it is sufficiently loaded with crabs, and to avoid releasing the lid, while the basket is immersed which will allow crabs to swim away. Some baskets, which freely admit water, are not sturdy enough to lift the weight of a catch of crabs, especially when wet. The separation of the basket can result in the loss of the entire catch.

There is a need for a floating crab holder, which is constructed of sturdy material, to confine caught crabs and which can remain in the water during the crabbing activity and while crabs are deposited into it.

### SUMMARY OF THE INVENTION

It is an object of the present invention to provide a sturdy floating crab holder which can remain in the water during a day of crabbing. It is another object of the invention to provide a floating crab holder which can be opened, for the deposit of newly caught crabs, without risking the loss of the catch. It is a further object of the invention to provide a floating crab holder which will not collapse when it is removed from the water and set down.

The floating crab holder, of the present invention is comprised of a platform and a mesh assembly. The platform is constructed of floating material and is generally planar and rigid, with top and bottom surfaces and one or more generally vertical edges. The mesh assembly is constructed of negatively buoyant material and is also rigid. The mesh assembly is affixed to the platform and depends therefrom, forming an enclosure below the bottom surface of the platform, for holding caught crabs. The platform is provided with an aperture communicating with the enclosure, for depositing crabs and means for selectively closing the aperture.

Additionally, the top surface of the platform has means for attaching a tether and means for grasping the floating crab holder, so that it may be lifted. Ideally, the platform is provided with sufficient flotation to allow an amount of freeboard which will prevent crabs from swimming out of the enclosure while the aperture is open and the floating crab holder is in the water. The means for selectively closing the aperture is intended to be operated with one hand, so that the aperture can be opened with one hand while a crab is being deposited with one's other hand. The mesh is selected to have large openings to freely admit water but sufficiently small to prevent the escape of the caught crabs. The mesh is selected to be sufficiently rigid to support the weight of the floating crab holder, without deforming. It is intended that the floating crab holder can rest on a hard surface and retain its shape, so that the aperture can be opened without having the top surface of the platform come within reach of a walking crab.

The floating crab holder can be used on land, on a pier, or in a boat. It is placed in the water and allowed to float, with a tether attached. When a crab is caught, the floating crab holder may be drawn near, with the tether, and the crab can be deposited. If the user desires, the holder can be lifted out of the water, while a crab is being deposited. In addition to the advantage of keeping the caught crabs in the water, the present invention has the added advantage of saving space in the boat or on the pier, where the crabbers are working. This is particularly valuable when a small boat is being used and space is at a premium.

### BRIEF DESCRIPTION OF THE DRAWINGS

FIG. 1 is a side perspective view of the floating crab holder

FIG. 2 is a top plan view of the floating crab holder, with the aperture closed

FIG. 3 is a side perspective view of the floating crab holder with the aperture open

FIG. 4 is a side plan view of the platform from within the aperture, having four parts 4A-4D, showing the rotation and sliding movement of the selective closing means, with arrows indicating the direction of movement

### DESCRIPTION OF THE PREFERRED EMBODIMENT

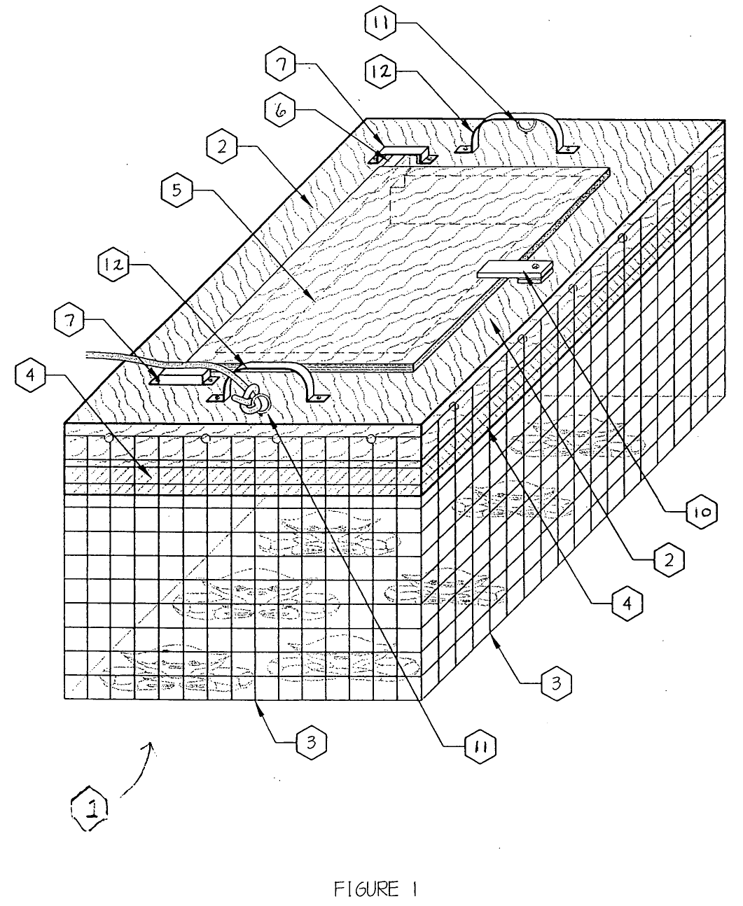

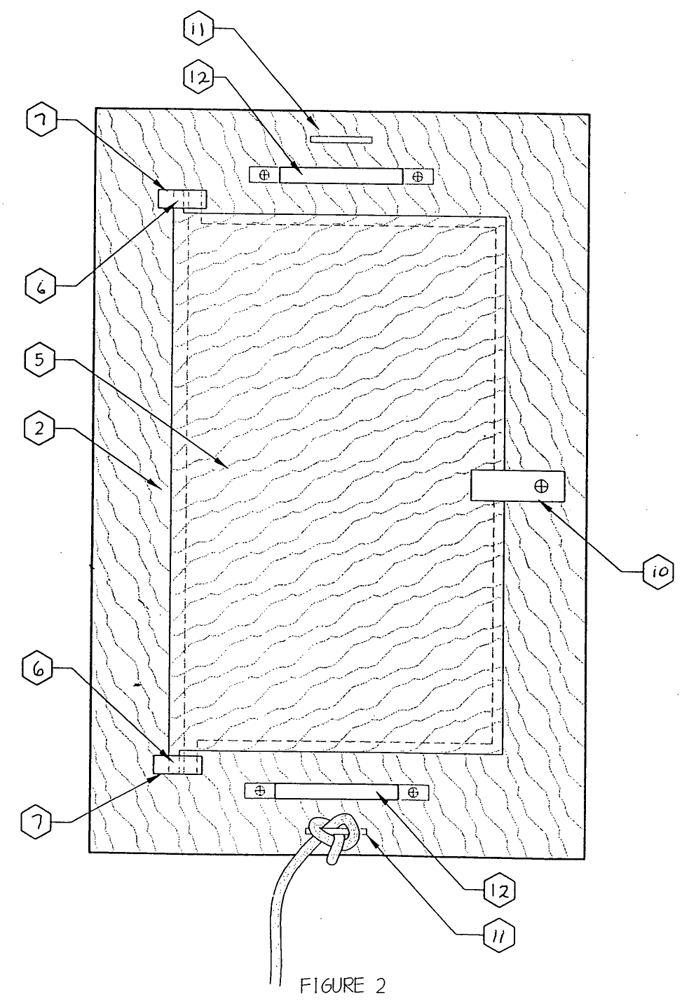

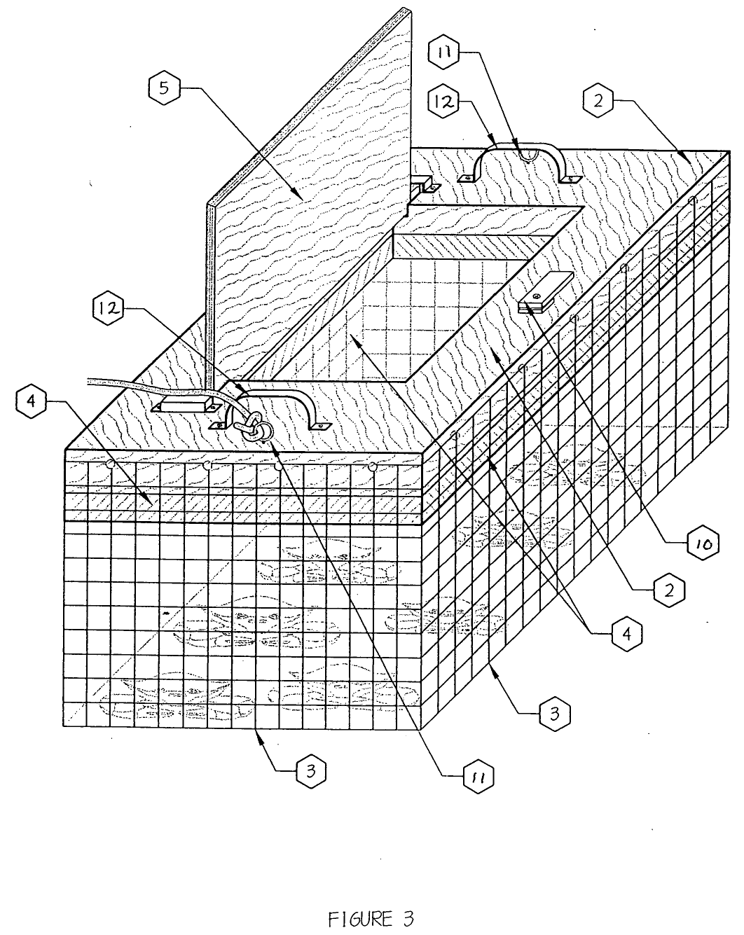

The present invention comprises a floating crab holder 1 as shown in FIG. 1, FIG. 2 and FIG. 3, having a platform 2 and a mesh assembly 3. The preferred embodiment has a platform 2 constructed of wood, in a generally rectangular shape, and being generally planar with a top surface, a bottom surface and generally vertical edges. In the preferred embodiment, the platform 2 has dimensions of 30 inches by 14.5 inches; however, the dimensions may be varied to suit the needs of the user. The use of pressure treated wood is preferable to extend the useful life of the invention. The platform 2 has buoyant panels 4, of floating material such as styrofoam, affixed to the bottom surface, by gluing, tacking or other means, for increased flotation.

The mesh assembly 3 is preferably constructed of wire mesh, having generally square openings of approximately 1.5 inches in width and height and formed of medium gauge wire. The wire mesh is cut and folded to form an enclosure having a bottom of generally rectangular shape, and dimensions approximately equal to the bottom surface of the platform. The wire mesh is folded to form four upwardly extending sides, integral with the bottom, each side contacting another side at a seam having an angle of approximately ninety degrees. The sides being joined to each other at the seams. In the preferred embodiment, the sides are joined by bending wire around and through the mesh openings near the seams. The mesh assembly 3 is preferably formed of rust inhibiting material, such as galvanized wire and/or coated with a rubberized compound, to extend its useful life. The mesh assembly 3 is affixed to the platform by stapling, nailing or other fastening means to form an enclosure bounded by the four sides and bottom of the mesh assembly 3 together with the platform 2.

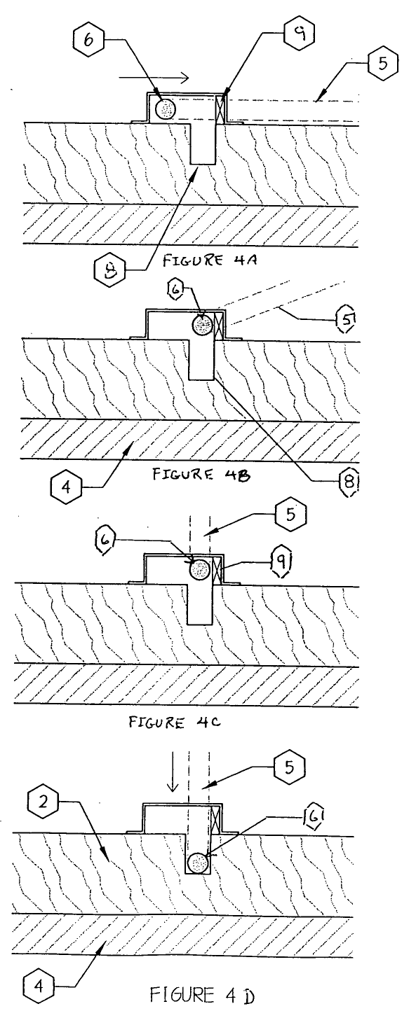

The platform 2 has a selectively closable aperture communicating with the enclosure, In the preferred embodiment, the aperture is generally rectangular and has dimensions of approximately 23 inches by 8 inches and is selectively closed by a generally rectangular planar door 5 attached to the top surface of the platform 2. The said door 5 having a front edge, a back edge and two side edges. Said door is provided with a pair of cylindrical pins 6 affixed to and extending outwardly from opposite side edges and proximate to said back edge. A pair of brackets 7 are affixed to the top surface of said platform and cooperate with said pins 6 for attaching said door 5 to said top surface, as shown in FIG. 4. It is preferred that each of said brackets 7 is configured to have a portion fixed in a parallel spaced apart relation to said top surface and defining an elongated space therebetween. Each of said pins 6 is disposed within an elongated space such that said pins 6 can freely rotate about a longitudinal axis and freely slide within said elongated space. Said pins 6 may be integrally formed with said door 5 or may be separately formed of the same or different material. Wood and metal as well as other materials are suitable for said pins 6 and said door 5.

In the preferred embodiment, said top surface of the platform 2 is provided with a pair of channels 8 each communicating with said elongated space and having an open end communicating with said aperture, as shown in FIG. 4A-4D. Each of said channels 8 is located and sized to receive one of said pins 6 and a portion of said door 5, slideably inserted edgewise and generally perpendicular to said top surface, for holding said door 5 in an upright and open position, as shown in FIGS. 3 and 4A-4D.

It is intended that said door 5 may be rotated about said pins to an upright and open position. If the user desires, the door 5 may be slideably moved to a position in alignment with said channels 8, as shown in FIGS. 4A and 4B, and pushed downward into said channels 8, as shown in FIGS. 4C and 4D, for retaining said door in an upright and open position, as show in FIG. 3. The portion of said brackets 7 defining the elongated space may be provided with a bumper 9 to assist the user in locating the position of alignment. When a closed position is desired, said door 5 may be lifted out of said channels 8 and slideably moved away from alignment with said channels 8 and rotated to the closed position, as shown in FIG. 2. The platform 2, of the preferred embodiment has one or more rotatable tabs 10 affixed to the top surface at a point where they may be manually rotated over a portion of the door 5, proximate to the front edge, when the aperture is closed, to releasably secure the door 5 in closed position.

The said platform 2 having an eye bolt 11 affixed to the top surface, for attaching a tether and handles 12 for lifting the floating crab holder 1.

Having fully described the present invention, with reference to certain preferred means of accomplishing the objects thereof, it will be recognized that equivalent variations are possible. For example the dimensions of the crab holder 1 may be varied considerably without departing from the spirit of the present invention. The size of the vehicle used to transport the crabbers and their equipment may have a bearing on the ideal size of the crab holder 1. In a situation where crabbers are working from shore, the crab holder 1 may be floated in relatively shallow water, which may require relatively large dimensions of the platform 2 and relatively less height of the mesh assembly 3.

We claim:

1. A floating crab holder comprising:
a platform of rigid and buoyant material;
said platform having a generally planar shape with a top surface and a bottom surface;
a mesh assembly affixed to the bottom surface of said platform and depending therefrom;
said mesh assembly being formed of rigid material having a plurality of openings, said openings being sized to freely admit water and to prevent the passage of crabs;
said mesh assembly being configured for forming an enclosure below the bottom surface of said platform;
said platform having an aperture in said top surface, said aperture communicating with said enclosure for depositing and removing crabs.

2. The floating crab holder of claim 1, wherein said mesh assembly is configured to have a surface generally parallel to said platform for resting said crab holder on a firm support surface in a generally upright orientation.

3. The floating crab holder of claim 1, further comprising means for selectively closing said aperture.

4. The floating crab holder of claim 3 wherein said means for selectively closing said aperture includes means for retaining said selectively closing means, in an open position.

5. The floating crab holder of claim 3, further comprising means for retaining said selectively closing means, in a closed position.

6. The floating crab holder of claim 1, further comprising a door, on said platform, for selectively closing said aperture.

7. The floating crab holder of claim 6, wherein said door includes a plurality of outwardly extending pins and further comprising a plurality of brackets and channels, on said platform, cooperating with said pins for rotatably supporting said door and for retaining said door in an open position.

8. The floating crab holder of claim 1, further comprising means for attaching a tether affixed to said platform and handles for lifting, affixed to said platform.
